(19) United States
(12) Patent Application Publication
(10) Pub. No.: US 2026/0154558 A1
(43) Pub. Date: Jun. 4, 2026

(54) LEARNING METHOD

(71) Applicant: TOYOTA JIDOSHA KABUSHIKI KAISHA, Toyota-shi (JP)

(72) Inventor: Tetsuya HASHIMOTO, Tokyo (JP)

(73) Assignee: TOYOTA JIDOSHA KABUSHIKI KAISHA, Toyota-shi (JP)

(21) Appl. No.: 19/390,624

(22) Filed: Nov. 16, 2025

(30) Foreign Application Priority Data
Dec. 4, 2024 (JP) 2024-211147

(51) Int. Cl. G06N 3/09

(52) U.S. Cl. CPC G06N 3/09

(57) ABSTRACT

A learning method includes inputting text data, of which a source is clearly known, into a large language model, in pre-training of the large language model, acquiring values of an intermediate layer of the large language model, when performing pre-training of the large language model with the text data as input, and performing learning to generate a learning model by supervised learning, with the values of the intermediate layer that are acquired as input data, and source information indicating the source of the text data as correct answer data.

### CROSS-REFERENCE TO RELATED APPLICATION

This application claims priority to Japanese Patent Application No. 2024-211147 filed on Dec. 4, 2024. The disclosure of the above-identified application, including the specification, drawings, and claims, is incorporated by reference herein in its entirety.

### BACKGROUND

### 1. Technical Field

The present disclosure relates to a technical field of a learning method.

### 2. Description of Related Art

As one example of this type of method, a method has been proposed in which a large language model (LLM) is used to generate query data based on documents, and pairs of the documents and the query data are used to train a search model for a conversational bot (see Japanese Unexamined Patent Application Publication No. 2023-076413 (JP 2023-076413 A)).

### SUMMARY

For example, in a service that uses a large language model, output of the large language model may contain all or part of copyrighted material of another party. In this case, copyright-related problems may arise. It should be noted that a large language model is a language model that is constructed using a very large dataset and deep learning technology.

The present disclosure has been made in consideration of the above problems, and an object thereof is to provide a learning method that can reduce risk of rights infringement.

A learning method according to an aspect of the present disclosure includes inputting text data, of which a source is clearly known, into a large language model, in pre-training of the large language model, acquiring values of an intermediate layer of the large language model, when performing pre-training of the large language model with the text data as input, and performing learning to generate a learning model by supervised learning, with the values of the intermediate layer that are acquired as input data, and source information indicating the source of the text data as correct answer data.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a concept of a large language model; and

FIG. 2 is a flowchart showing a learning method according to an embodiment.

### DETAILED DESCRIPTION OF EMBODIMENTS

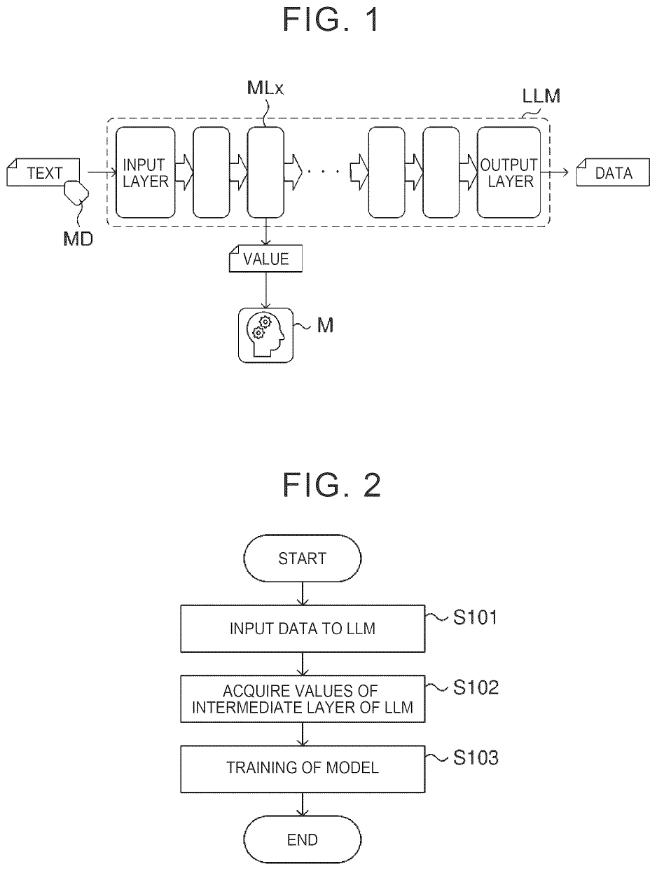

An embodiment of a learning method will be described with reference to FIGS. 1 and 2. In FIG. 1, a large language model (LLM) has an input layer, an output layer, and a plurality of intermediate layers. Note that “intermediate layers” may also be called “hidden layers”.

Training a large language model may include pre-training and post-training. For example, in pre-training, a large language model is trained using pre-training corpus data (i.e., a great amount of text data). Specific examples of pre-training include “next token prediction” and “masked token prediction”. Note that the present embodiment is not related to post-training, and accordingly detailed description thereof will be omitted.

Now, pre-training corpus data may include all or part of copyrighted material. Output of a large language model that is trained using such pre-training corpus data may contain all or part of copyrighted material. In this case, copyright-related problems may arise.

In the present embodiment, a method for training a model (model M described later) that estimates data that is the basis for a reply (i.e., output) of a large language model will be described. It is assumed as a premise that the pre-training corpus data contains text data of which a source is clearly known. It is assumed that metadata (see sign MD in FIG. 1) including source information indicating the source is added to the text data of which the source is clearly known.

In pre-training, when text data is input to a large language model, values of an intermediate layer (e.g., intermediate layers MLx) of the large language model are affected by the text data that is input. Also, in the pre-training, the data that is output from the large language model is affected by the text data that is input to the large language model. From this, it can be said that the values of the intermediate layers (e.g., intermediate layers MLx) of the large language model are affected by the data that serves as the basis for output of the large language model. Accordingly, in the present embodiment, a model M is constructed that uses metadata that is added to text data, and values in the intermediate layers, to estimate data that is the basis for the reply (i.e., output) of the large language model. Note that the model M may be constructed by a server (e.g., a cloud server).

This will be described in detail with reference to the flowchart in FIG. 2. In pre-training of a large language model, text data to which metadata, including source information, is added, is input to the large language model (step S101). Values of intermediate layers (e.g., intermediate layers MLx) of the large language model, when pre-training of the large language model is performed with input text data as input, are acquired (step S102). Thereafter, the source information that is included in the metadata that is added to the input text data in the processing of step S101, and the values of the intermediate layers that are acquired in the processing of step S102, may be associated with each other. The source information and the values of the intermediate layers serve as training data that is used to train the model M.

The processing of steps S101 and S102 are repeated until a sufficient amount of training data is collected for use in training the model M. After a sufficient amount of training data (i.e., source information and values of the intermediate layer) has been collected, the model M is trained by supervised learning, with the values of the intermediate layer as input data and the source information as correct answer data (step S103). Such a model M may be a learning model relating to a multi-label classifier.

The model M that is constructed as described above may acquire values of intermediate layers of the large language model when the large language model that is constructed generates a reply as to an input (e.g., a question). The model M uses the values of the intermediate layers that are acquired, as input, to estimate the source of the text data that is used by the large language model when generating the reply.

### Technical Effects

The model M that is constructed by the learning method according to the present embodiment estimates the source of the text data that is used when the large language model generates a reply. For example, referencing the sources that are estimated by the model M (i.e., the data serving as the basis for the reply of the large language model), enables determination to be made relatively easily regarding whether copyright-related problems will arise. Thus, the learning method according to the present embodiment can reduce the risk of rights infringement.

Various aspects of the disclosure that are derived from the above-described embodiment will be described below.

A learning method according to an aspect of the disclosure includes inputting text data, of which a source is clearly known, into a large language model, in pre-training of the large language model, acquiring values of an intermediate layer of the large language model, when performing pre-training of the large language model with the text data as input, and performing learning to generate a learning model by supervised learning, with the values of the intermediate layer that are acquired as input data, and source information indicating the source of the text data as correct answer data.

In the learning method according to the above aspect, the learning model may be a learning model that estimates the source of the text data that is used when the large language model generates a reply. In the learning method of the above aspect, the learning model may be a learning model relating to a multi-label classifier.

The present disclosure is not limited to the above-described embodiments, and may be modified as appropriate without departing from the gist or concept of the disclosure as can be read from the claims and the entire specification, and learning methods involving such modifications are also included in the technical scope of the present disclosure.

What is claimed is:

1. A learning method, comprising:
inputting text data, of which a source is clearly known, into a large language model, in pre-training of the large language model;
acquiring values of an intermediate layer of the large language model, when performing pre-training of the large language model with the text data as input; and
performing learning to generate a learning model by supervised learning, with the values of the intermediate layer that are acquired as input data, and source information indicating the source of the text data as correct answer data.

2. The learning method according to claim 1, wherein the learning model is a learning model that estimates the source of the text data that is used when the large language model generates a reply.

3. The learning method according to claim 1, wherein the learning model is a learning model relating to a multi-label classifier.
